(19) United States
(12) Patent Application Publication
(10) Pub. No.: US 2025/0119411 A1
(43) Pub. Date: Apr. 10, 2025

(54) Message Attestation for Sealed Sender

(71) Applicant: Apple Inc., Cupertino, CA (US)

(72) Inventors: Catherine Yun, Woodside, CA (US); Elliot S. Briggs, Carmel, CA (US); Simon J. Gornall, San Jose, CA (US); Michael J. Hashe, New Haven, CT (US); Steven A. Myers, San Jose, CA (US); Andrew M. Pace, Gloucestershire (GB); Yannick L. Sierra, San Francisco, CA (US); Phillip T. Tao, San Jose, CA (US)

(21) Appl. No.: 18/909,442

(22) Filed: Oct. 8, 2024

Related U.S. Application Data
(60) Provisional application No. 63/588,745, filed on Oct. 8, 2023.

(51) Int. Cl. H04L 9/40; H04L 9/14; H04L 9/32

(52) U.S. Cl. CPC H04L 63/0421; H04L 9/14; H04L 9/3247

(57) ABSTRACT

Techniques are disclosed relating to improving secure message communication. In various embodiments, a message delivery server receives a request to deliver an encrypted message from a sender to a recipient. The encrypted message obfuscates the identity of the sender such that the message delivery server is unable to determine the identity of the sender. The message delivery server determines whether to deliver the encrypted message based on a signed attestation received with the request and, based on the determining, delivers the encrypted message to the recipient. In some embodiments, the determining includes verifying the signed attestation using a verification key provide by the sender. In some embodiments, the encrypted message is an email, a text message, a push notification, or a video or audio call request.

The present application claims priority to U.S. Prov. Appl. No. 63/588,745, entitled “Message Attestation for Sealed Sender,” filed Oct. 8, 2023, which is incorporated by reference herein in its entirety.

### BACKGROUND

### Technical Field

This disclosure relates generally to computer security, and, more specifically, to improving secure message communication.

### Description of the Related Art

A variety of techniques have been developed to enhance email security. One effective technique is using end-to-end encryption protocols such as pretty good privacy (PGP) or secure/multipurpose internet mail extensions (S/MIME), which may ensure that only the intended recipient can read the email content. Email servers can also employ secure authentication protocols such as transport layer security (TLS) and domainkeys identified mail (DKIM) to verify sender identities and prevent spoofing attacks. Additionally, enabling two-factor authentication for email accounts can add an extra layer of security by requiring both a password and a code sent to a user's mobile device or other trusted device. Implementing robust spam filters and gray listing can help block malicious emails from reaching users' inboxes. Using secure implementations of email protocols such as post office protocol (POP) and internet message access protocol (IMAP) when downloading emails from the server can also ensure that sensitive information remains protected during transmission.

### BRIEF DESCRIPTION OF THE DRAWINGS

FIG. 1 is a block diagram illustrating an example of a message filtering system, in accordance with some embodiments.

FIG. 2 is a block diagram illustrating an example of a ring-signature exchange performed by the message filtering system, in accordance with some embodiments.

FIG. 3 is a block diagram illustrating an example of a verifiability oblivious pseudorandom function (VOPRF) exchange performed by the message filtering system, in accordance with some embodiments.

FIG. 4 is a block diagram illustrating an example of a nested-signature exchange performed by the message filtering system, in accordance with some embodiments.

FIGS. 5A-C are flow diagrams illustrating examples of methods implemented by components of the message filtering system, in accordance with some embodiments.

FIG. 6 is a block diagram illustrating an example computing device implementing functionality described herein.

FIG. 7 is a diagram illustrating example applications for systems and devices implementing functionality described herein.

Communication security can sometimes be in contention with other desirable objectives. For example, in the case of simple mail transfer protocol (SMTP), email traffic can often be communicated between mail servers in an unencrypted form allowing intermediaries to learn message contents as well as the identities of senders and recipients. While various protocols have been developed to ensure end-to-end encryption, such as those noted above, this added security can complicate message filtering (e.g., spam blocking) as a message delivery server may be unable apply particular filters to encrypted message content or an encrypted sender's identity. This problem can also extend to other types of communications such as secure messaging services, push notification services, phone call services, etc.

The present disclosure describes embodiments in which a message sender can provide a signed attestation to a message delivery server (e.g., associated with email, short messaging service (SMS), session initiation protocol (SIP), etc.) to indicate that the sender is authorized to send a message to a recipient without revealing the identity of the sender (or the message contents) to the message delivery server (or any other intermediary). As will be discussed in various embodiments, a sender device and a recipient device may participate in a pre-authorization step in which the sender device receives cryptographic material, which may be provided by the recipient device, for obtaining a signed attestation. The sender device can then send, to a message delivery server associated with the recipient, a request to deliver an encrypted message that obfuscates/seals the identity of the sender such that the message delivery server is unable to determine the identity of the sender. The message delivery server, however, can determine whether to deliver (or filter) the encrypted message based on a signed attestation received with the request. In various embodiments, the signed attestation is further implemented in a manner to obfuscate the sender's identity with respect to the signed attestation to ensure that the message delivery server (or some other intermediary) cannot determine the identity of the sender from the signed attestation (or more generally determine an association of the sender's current message to other messages sent by the sender). Various revocation techniques will also be discussed in which a recipient wanting to rescind authorization provided to a given sender can send a revocation request to the message delivery server.

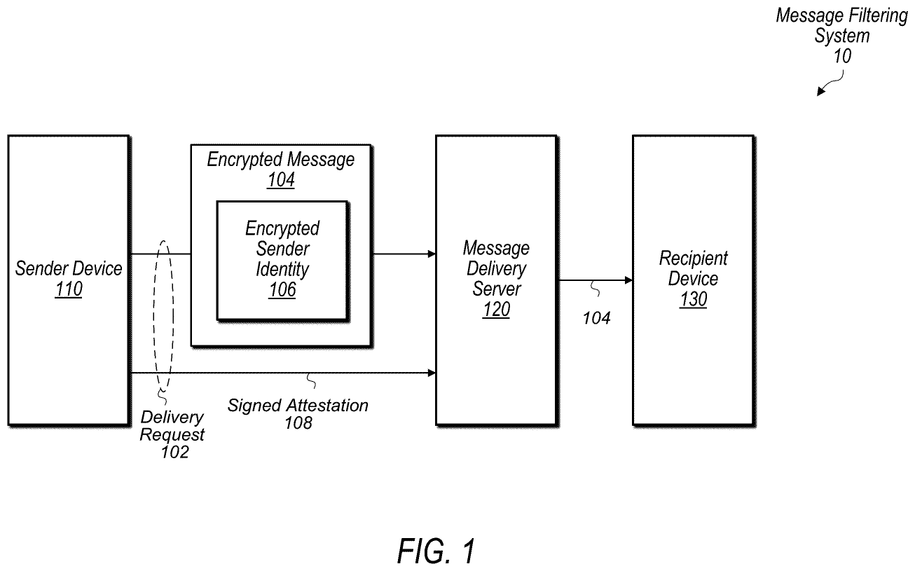

Turning now to FIG. 1, a block diagram of a message filtering system 10 is depicted. In the illustrated embodiment, system 10 includes a sender device 110, a message delivery server 120, and a recipient device 130. In some embodiments, system 10 may be implemented differently. For example, system 10 may include another message delivery server associated with the sender device 110. Furthermore, although various examples are described with respect to sending messages, the embodiments described herein may have broader application than merely message communication.

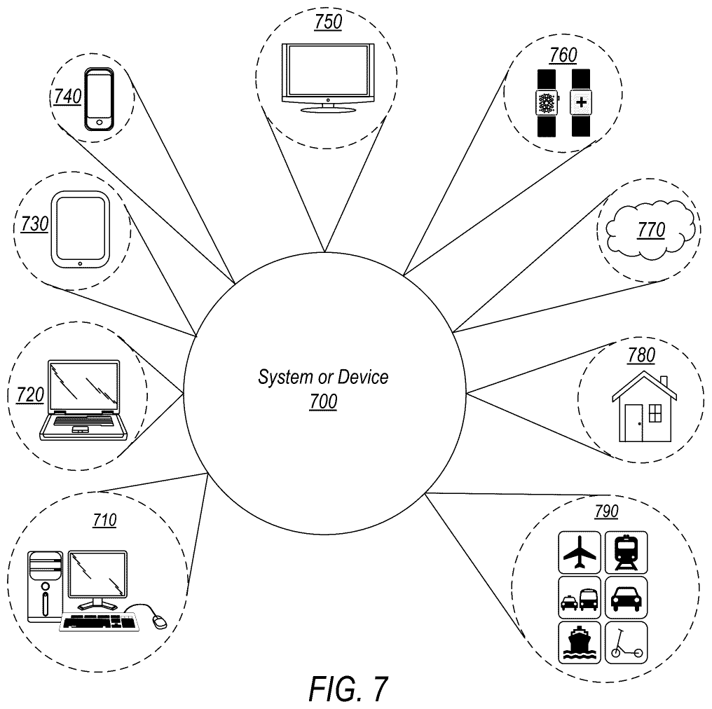

Sender device 110 and recipient device 130 are devices configured to exchange messages 104 with one another. Devices 110 and 130 may correspond to any suitable computing devices/systems such as phones, tablets, laptops, wearable devices (e.g., watches, head mounted displays, etc.), desktop computers, or any of the other examples discussed below with respect to FIG. 7. Messages 104 may also include any suitable type of messages such as text messages (e.g., SMS, multimedia messaging service (MMS), rich communication services (RCS), etc.), email, push notifications, SIP requests to set up a video or audio call, video conferencing requests, etc. In some instances, users of devices 110 and 130 may want to securely communicate messages 104, which may include obfuscating/sealing an identity of the sender of message 104. For example, as shown in FIG. 1, sending device 110 can send an encrypted message 104 including an encrypted sender identity 106, which may include a sender's email, phone number, name, user identifier, etc. In other embodiments, the sender's identity 106 can be obfuscated using other techniques such as hashing identity 106, using an alias, removing the identity 106, etc. In doing so, sending device 110 can protect contents of message 104 and/or the sender's identity 106 from intermediaries (such as server 120, the internet service providers (ISPs) associated with devices 110 and 130, etc.) monitoring communications between devices 110 and 130. While device 110 may encrypt message 104's contents and the identity 106 of the sender, in various embodiments, the identity of the recipient may remain unencrypted so that message delivery server 120 can identify the correct recipient.

Message delivery server 120 is an intermediary computing system facilitating communication of messages 104 between devices 110 and 130. In some embodiments, server 120 implements a message delivery agent (MDA) that can receive messages 104 and store them in a mailbox accessible to recipient device 130. For example, server 120 may implement POP, IMAP, messaging application programming interface (MAPI), etc. for incoming email messages 104. In some embodiments, server 120 may also implement a message transfer agent (MTA) capable of communicating messages via a transfer protocol such as SMTP. In some embodiments, server 120 implements a proxy for device 130 to receive messages 104 on behalf of device 130. In various embodiments, server 120 applies one or more filters to incoming messages 104 (and potentially outbound messages) to allow or deny a given message 104 such as implementing spam filtering for recipient device 130. As noted above, however, the encryption of message 104 contents including the sender identity 106 can interfere with this filtering ability.

In the illustrated embodiment, sender device 110 includes sends a delivery request 102 for encrypted message 104 that further includes a signed attestation 108 attesting to the trustworthiness of sender device 110—and device 110 being authorized to send messages 104 to recipient device 130. In response to receiving the request 102, message delivery server 120 can determine whether to deliver encrypted message 104 based on a verification of signed attestation 108. Accordingly, in response to a successful verification of attestation 108, server 120 may determine to deliver message 104 to recipient device 130 without being able to apply messages filters to message 104—or even knowing the identity of the sender. In response to an unsuccessful verification of attestation 108 (or attestation 108 merely not being present), server 120 may decline to deliver message 104. In some embodiments, recipient device 130 authorizes a sender device 110 to send messages 104, by sending encrypted cryptographic material to device 110 for obtaining signed attestations 108. As will be discussed, this cryptographic material may include cryptograph keys (e.g., digital signature algorithm (DSA) key pairs), tokens, material for deriving cryptographic keys, key signatures, etc. In some embodiments, recipient device 130 also provides cryptographic material, such as verification keys, to message delivery server 120 to verify received attestations 108.

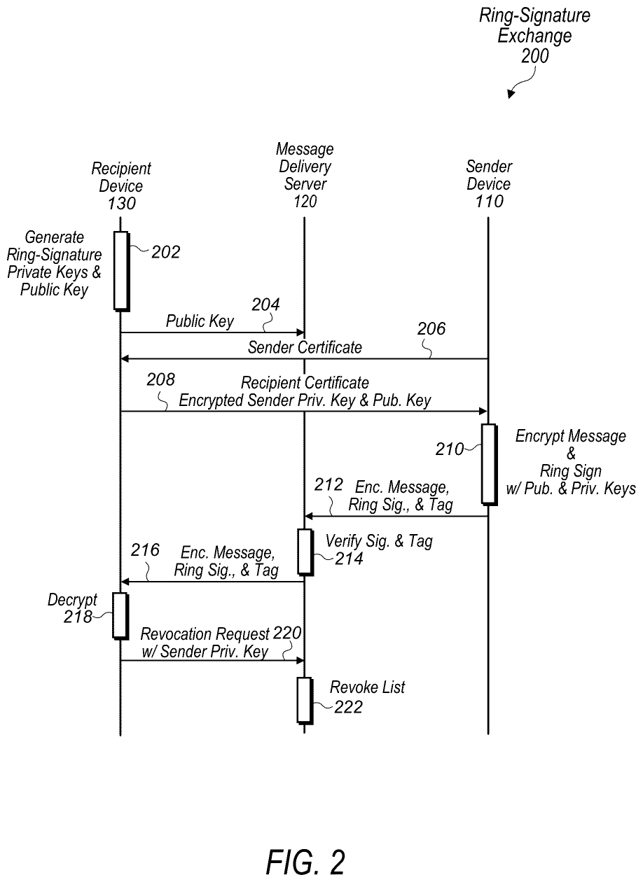

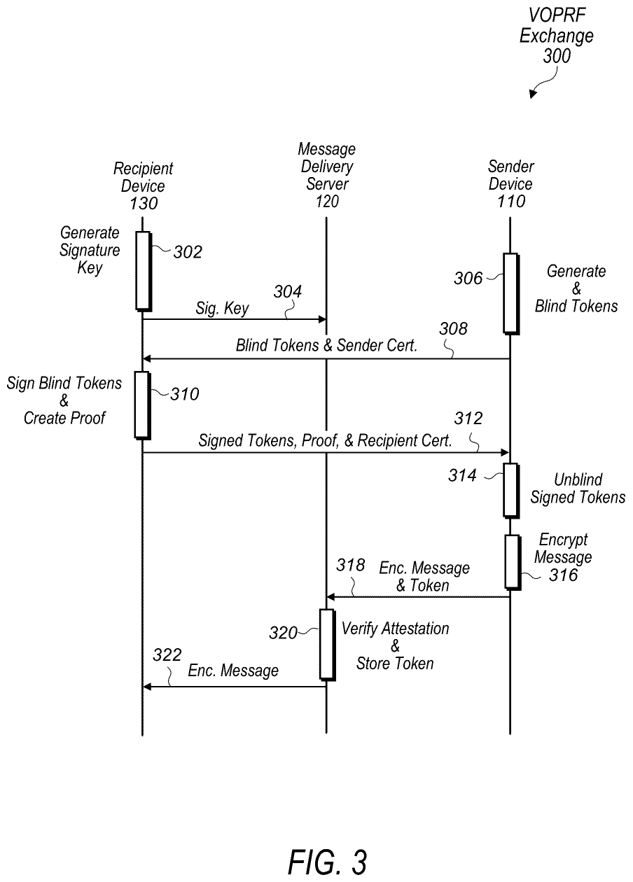

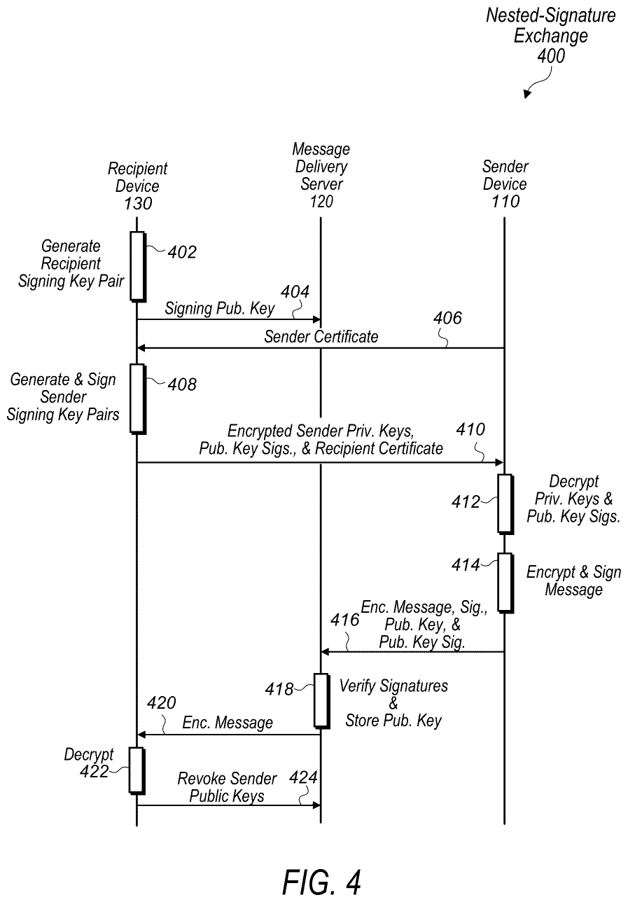

In various embodiments, signed attestations 108 are implemented in a manner to obfuscate the sender's identity to ensure that an intermediary cannot determine the identity 106 of the sender from the signed attestation 108 (or more generally determine an association of the sender's current message 104 to other messages sent by the sender). For example, in some embodiments discussed below with FIG. 2, recipient device 130 generates a set of ring signature keys for multiple devices 110 to enable them to generate ring signatures that are verifiable using a single common verification key. Recipient device 130 can then distribute the ring signature keys to the sender devices 110 and the single common key to message delivery server 120—thus preventing server 120 from identifying a given sender from any other sender in the set. In some embodiments discussed below with FIG. 3, recipient device 130 provides a batch of signed, one-time-use tokens that can be unpacked by sender device 110 and individually applied to messages 104. To further obfuscate the sender's identity, tokens may be signed using blind signatures and verified by the server using a VOPRF. In some embodiments discussed below with FIG. 4, recipient device 130 sends a set of one-time-use signature private keys to sender device 110 while also signing their corresponding public keys. Sender device 110 can then generate a signed attestation 108 using one of the private signature keys. Mail delivery server 120 can then verify the signed attestation 108 using a public key of receipt device 130 corresponding to the private key used by receipt device 130 to sign sender devices 110's private keys. Attestations 108 may also implemented using other suitable techniques such as keyed-verification anonymous credentials, various post-quantum algorithms, etc.

In various embodiments, signed attestations 108 are also implemented in a manner that allows a recipient device 130 to rescind a sender device 110's authorization to send messages 104 via message delivery server 120. For example, if a sender device 110 is abusing its authorization by sending spam, recipient device 130 can send a revocation request to message delivery server 120 to stop further delivery of messages 104 from sending device 110. As will be discussed, this revocation request can identify a token verification key, a set of public keys corresponding to a set of private keys used by the sender to sign the attestations, a ring signature key of the sender and usable to identify a message signature tag appended by the revoked sender to an encrypted message, etc.

### Ring Signatures

Turning now to FIG. 2, a communication diagram of a ring-signature exchange 200 is depicted. As will be discussed, exchange 200 includes a sender device 110 creating an attestation 108 by generating a ring signature (corresponding to signed attestation 108) using a private/secret ring signature key, which can be verified by message delivery server 120 using a ring signature public key. As used herein, a “ring signature” is a term of art referring to a particular type of digital signature in which any member of a set of members can sign on behalf of the set such that the signature can be validated as belonging to the set while hiding which particular member in the set signed the message. Ring signatures can be useful because they allow a member in a set of preauthorized senders to sign a message (thereby proving that the member has been preauthorized) without revealing the member's identity (e.g., to message delivery server 120). In some embodiments, ring signatures implemented herein use standard cryptographic assumptions (discrete log, decisional Diffie-Hellman). Group signatures can also rely on nonstandard cryptographic assumptions (bilinear maps, strong RSA), which allow them to have better performance and smaller signature sizes.

In the illustrated embodiment, exchange 200 begins, at 202, with recipient device 130 generating n signing key pairs, where n is the number of senders in the anonymity set and the number of secret keys in a ring. Recipient device 130 then creates a ring public key rpk A for that set of n key pairs-the ring public key including group elements of the public keys rpk i of the n signing key pairs and for all i in the ring. At 204, recipient device 130 sends the ring public key rpk A to its message delivery server 120 but retains the private/secret keys rsk i of the n signing key pairs. In various embodiments, recipient device 130 can use a key derivation function (KDF) to generate all of the rsk i keys, so that it does not have to store all the ring secret keys (after generating the ring public key rpk A), but only stores the derivation key. This can reduce recipient client-side memory requirements. In some embodiments, recipient device 130 can sync its ring keys across other devices authorized to receive encrypted messages 104 such as those belonging to the same user of device 130. These can include the ring public key rpk A and ring secret keys rsk i for all i in the ring. The ring key information (secret and public keys) can be rotated based on the lifetime of the ring.

At 206, to establish an encrypted channel with which to receive sender device 110's ring secret key rsk B, sender device 110 sends, to recipient device 130, its certificate, which, in some embodiments, is the sender's S/MIME certificate. At 208, recipient device 130 can encrypt the sender's secret key rsk B to sender device 110 (using the sender's public key included in its certificate) and then send the secret key along with the ring public key rpk A and the recipient's certificate for encrypting message 104. In some embodiments, recipient device 130 encrypts the entirety of the message sent at 208. This, however, could result in sender device 110's message delivery server (not shown) rejecting this message if it implements spam filtering that does not allow encrypted messages to pass through to sender device 110. Therefore, in other embodiments, the message sent at 208 may be unencrypted but include an encrypted payload enc B (rsk B). In response to receive this message, sender device 110 can decrypt its contents using the secret key corresponding to the previously sent certificate. In some embodiments, sender device 110 can sync its ring key information across other devices authorized to send encrypted messages 104 such as those belonging to the same user of device 110. This information can include its ring secret key rsk i and the ring public key rpk.

At 210, when a user of sender device 110 wants to send a user of recipient device 130 an encrypted message 104, sender device 110 encrypts the message 104 using the public key included in device 130's certificate. Device 110 then generates a signed attestation 108 by signing the encrypted message 104 to produce a ring signature ring sig B using its secret key rsk B and the ring public key rpk A—the ring signature serving as proof that it has been authorized. In some embodiments, this signature generation may use elliptic curve libraries (such as in corecrypto, bouncycastle, etc.), a ring signature based protocol (such as DualDory-EC relying on standard cryptographic assumptions DualRing), BBS Signatures, etc.

In the illustrated embodiment, sender device 110 also generates a message signature tag used for verifier-local revocation (VLR) in which recipient device 130 can revoke sender device 110's ability to generate valid ring signatures without replacing the ring public key rpk A and everyone else's secret key's rsk i. In some embodiments, this tag is defined as a hash of encrypted message 104 raised to the power of the secret key: H (msg)\hat{ }rsk B along with a tag proof that the secret key rsk B is the same key as was used to make the ring signature.

At 212, sender device 110 sends, to message deliver server 120, a message delivery request 102 that includes the encrypted message 104, the ring signature, and the generated tag. In some embodiments, device 110 further includes its secret key rsk B in the encrypted message 104. As will be discussed, the inclusion of this key can enable recipient device 130 to revoke authorization of sender device 110. In other embodiments, instead of having the sender device 110 include rsk B in their encrypted message 104, recipient device 120 can store a mapping from authorized senders to rsk B values (or key derivation inputs) and recompute rsk B locally when performing revocation.

At 214, message deliver server 120 verifies that the ring signature ring sig B is a valid signature for the ring signature public key rpk A, without learning which key in the ring was used to make the signature (and thus not learning the identity of the sender). Message deliver server 120 also verifies that the signature tag is valid and not associated with any revoked secret keys. In some embodiments, this includes checking the tag proof against a list of revoked secret keys, by calculating H (msg)\hat{ }rsk j for each secret key rsk j in the revoked set. If the verifications are successful, message deliver server 120 provides, at 216, the encrypted message 104, ring signature, and tag to recipient device 130.

At 218, recipient device 130 receives and decrypts message 104. Recipient device 130 also decrypts rsk B and checks that it was used to create the appended signature tag. If a user of recipient device 140 determines that sender device 110 is abusing its authorization (e.g., message 104 was spam), recipient device 130 sends, at 220, a revocation request to message deliver server 120 to revoke acceptance of ring signatures (signed attestations 108) obtained using device 110's ring private/secret key rsk B. As noted above, in some embodiments, device 130 obtains rsk B from message 104. In other embodiments, device 130 rederives rsk B.

In response to receiving revocation request 220, message delivery server 120, at 222, stores device 110's secret key rsk B in a revocation list that enables server 120 to support VLR. As noted previously, VLR can be preferable over revocation via public key updating as updating the ring public key includes an extra step of communication to send the new public key to all the users in the ring. If another message 104 is received from sender device 110, server 120 can determine that the appended signature tag matches a signature tag generated using a secret key in its revoked list and deny the delivery request.

In theory, an authorized sender device 110 could use its ring secret key to make attestations 108 without any time limit. This, however, could result in server 120's revocation growing infinitely as new revoked private keys get continually added to the list. In order to bound the size of the revocation list, in some embodiments, server 120 imposes a lifetime limit for ring signature keys, so that the revoked keys in their ring can eventually be removed. Imposing a lifetime limit can also increases forward secrecy—e.g., if a secret key is leaked or revoked, messages 104 only have link-ability for the lifetime of that secret key. The lifetime could, for example, be over 1 months, to accommodate for the “birthday card” scenario. If a sender's secret key lifetime expires, then they can request a new authorization, or fall back to either non-sealed-sender encrypted message 104 (i.e., one that does not obfuscate identity 106) or an unencrypted message until a new ring signature key can be obtained from recipient device 130.

### VOPRFs

Turning now to FIG. 3, a communication diagram of VOPRF exchange 300 is depicted. As will be discussed, exchange 300 includes a sender device 110 generating a set of tokens (corresponding to signed attestation 108) that are sent to recipient device 130 for signature, which may be implemented using blind signatures to ensure that that tokens are known only to device 110 until they are used. When a user of device 110 wants to send a message 104, device 110 appends one of the signed tokens, which can be verified by server 120 applying a VOPRF to the signed attestation/token. As used herein, an oblivious pseudorandom function (OPRF) is a term of art referring to a two-party protocol for computing the output of a pseudorandom function (PRF). An OPRF can also satisfy a notion of verifiability, called a VOPRF. A VOPRF can ensure clients can verify that the server used a specific private key during the execution of the server's protocol. In some embodiments, exchange 300 may use post quantum VOPRFs, which may be constructed using a round-optimal VOPRF from ideal lattices, using Blind Signatures instead of VOPRFs, etc.

In the illustrated embodiment, exchange 300 begins, at 302, with recipient device 130 generating a signature key, which it provides to message delivery server 120, at 304, in order for server 120 to do spam filtering on the recipient's behalf. Because, in various embodiments, VOPRFs are private-key verifiable, the recipient is trusting server 120 to not abuse or leak this secret key. If the key is leaked, then anyone with possession of the key could generate valid attestations-and therefore be able to send spam to the recipient. In the unencrypted message and S/MIME4 encrypted message contexts, the recipient already trusts server 120 to do mail filtering on its behalf, but server 120 does not hold any secrets; however, with VOPRFs in some embodiments, server 120 is now trusted to hold a secret. In some embodiments, recipient device 130 can sync its secret key k across other devices authorized to receive encrypted messages 104. If any of the recipient's tokens were issued to a malicious sender, the recipient should sync revoked senders across its devices, so it can do client-side filtering. The tokens and secret key can be rotated based on the token and key lifetime.

At 306, sender device 110 generates a batch of tokens that are blinded using a blinding function to protect their contents. Device 110 then sends, at 308, the blinded tokens and its sender certificate to recipient device 130. In some embodiments, exchange 300 may include sender device 110 initially contracting recipient device 130 to see if device 130 is willing to patriciate in exchange 300, so that device 110 is not unnecessary storing blinding factors and the tokens while awaiting a response from recipient device 130.

At 310, recipient device 130 signs the blinded tokens using its generated signature key and creates a batched proof that the signing was done correctly. In other embodiments, however, to decrease the computational burden for device 130, server 120 can do this signing and proving step instead since server 120 is already trusted with the secret key k for verification. Recipient device 130 then sends the signed tokens, proof, and its certificate, which can all be encrypted using the public key in sender device 110's certificate received earlier.

In response to receiving this information, sender device 110 can, at 314, unblind the signed tokens. In some embodiments, sender device 110 can further sync its tokens across other devices authorized to send encrypted message 104. These tokens can include blinded unsigned tokens (scalars: t i, r i) for all potential recipients and signed tokens (scalar, group element: t i, W i) for all confirmed recipients.

At 316, when a user of sender device 110 is ready to send an encrypted message 104, device 110 selects an unspent token and binds it to encrypted message 104. Device 110 can send the encrypted message 104 and token to server 120 at 318.

At 320, message deliver server 120 verifies the token before passing the encrypted message 104 to the recipient at 322 if the token verifies correctly. In various embodiments, server 120 tracks spent tokens to ensure that sender device 110 (or some other device 110 that obtains a token) is not reusing them. To reduce the number of tokens to be tracked and the impact of a batch of tokens being compromised, server 120 may enforce a token lifetime limit, which, in some embodiments, may be greater than a year to support, for example, a “birthday card” use case (one encrypted message per year).

### Nested Signatures

Turning how to FIG. 4, a communication diagram of a nested-signature exchange 400 is depicted. As will be discussed, exchange 400 includes recipient device 130 generating multiple one-time-use key pairs for sender device 110, which uses them to sign messages 104 to produce attestations 108 for submission to message delivery server 120. This exchange 400 may be described as a nest-signature exchange as recipient device 130 signs the public keys of the one-time-use key pairs prior to providing the key pairs to sender device 110. Exchange 400 may use any suitable signature algorithm such as DSA or a post-quantum signature algorithm of choice, depending on which post-quantum signature schemes are standardized and widely adopted. Nested signature exchange 400 may also offer many of the same guarantees as VOPRFs, with the key difference being that it does not include the sender creating and storing blind tokens before they have been signed.

In the illustrated embodiment, exchange 400 begins, at 402, with recipient device 130 generating a signing key pair for signing one-time-use key pairs of sender device 110. At 404, recipient device 130 provides the public key of this signing key pair to message delivery server 120 to enable it to subsequent verify message signatures. In various embodiments, this key pair is used for multiple sender devices 110 so that server 120 cannot associate multiple messages 104 with the same device 110 based on the fact that they can be verified using the same signing public key received from device 130.

At 406, sender device 110 sends its sender certificate with a request to be authorized to send messages 104 to recipient device 130. In response, recipient device 130, at 408, generates multiple one-time-use key pairs of sender device 110 and signs the public keys using the signing private key generated at 402. At 410, recipient device 130 encrypts the private key keys and public key signatures using the public key included in the sender certificate and sends them with its recipient certificate to sender device 110. The message including these keys and signatures can either be unencrypted and signed, with an encrypted field, or encrypted and signed but without sealed sender. At 412, sender device 110 decrypts the private keys and public key signatures. In some embodiments, sender device 110 rederives the public keys corresponding to the private keys by applying a generator (e.g., an elliptic curve (EC) generator) to them to produce the corresponding public keys; in other embodiments, recipient device 130 provides the public keys at 410. In various embodiments, sender device 110 syncs this key material (e.g., sig A (pk i), sk i for I in batch) across other devices authorized to send messages 104.

At 414, when a user of sender device 110 is ready to send a message 104, device 110 encrypts the message 104 using the public key included in the recipient certificate and selects an unused one of the private keys to sign the encrypted message 104. Sender device 110, at 416, sends the encrypted message 104, the message signature (corresponding to attestation 108), the public key, and the public key signature generated by device 130 at 408.

At 418, message deliver server 120 verifies the received message signature before delivering the message 104. In the illustrated embodiment, this verification includes using the signing public key received at 404 to initially verify the public key signature for the public key received at 416. Server 120 may also check a list of already used public keys (or potentially revoked public keys) to confirm that sender device 110 is not reusing the public key. If this initial verification is successful, server 120 uses the public key received at 416 to verify the message signature against the encrypted message 104. If this verification is successful, server 120 delivers the encrypted message 104, at 420, to recipient device 130.

At 422, recipient device 130 decrypts the message 104 using the private key associated with its recipient certificate. If a user of recipient device 130 no longer wants to receive messages 104 from sender device 110 (e.g., due to the messages 104 being spam), recipient device 130 can send, at 424, a revocation request to message delivery server 120. Because, in the illustrated embodiment, recipient device 130 is generating the nested signing key pairs for sender device 110, recipient device 130 can store the public keys and revoke them in case the sender is malicious, by sending the revoked nested signing public keys, at 424, to message delivery server 120. Message deliver server 120 can keep a list of revoked keys with its list of seen keys and reject incoming encrypted messages 104 with those keys. To decrease storage overhead for recipient device 130, in some embodiments, device 130 can use a key derivation function to derive the nested signing key pairs from a primary key, so that it can store the derivation details instead of the key pairs.

### Methods

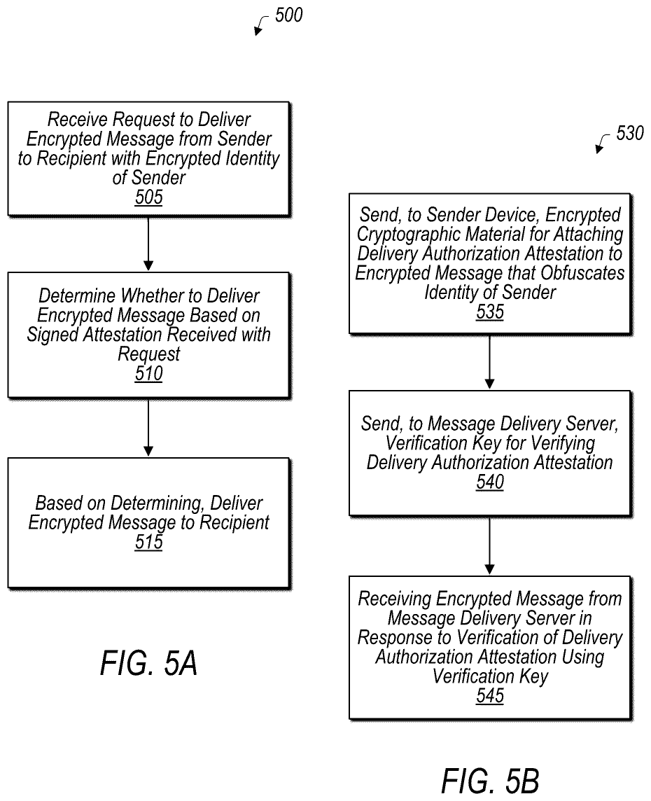

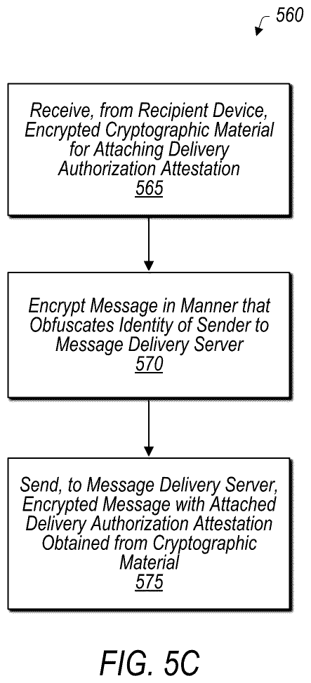

Turning now FIG. 5A, a flow diagram of a method 500 is depicted. Method 500 is one embodiment of a method performed by a computing system implementing a message delivery server such as message delivery server 120.

In step 505, a message delivery server receives a request (e.g., delivery request 102) to deliver an encrypted message (e.g., encrypted messages 104) from a sender (e.g., sender device 110) to a recipient (e.g., recipient device 130). In various embodiments, the encrypted message encrypts the identity of the sender (e.g., encrypted sender identity 106) such that the message delivery server is unable to determine the identity of the sender. In some embodiments, the encrypted message is an email, a text message, a push notification, or a video or audio call request. In various embodiments, the message encrypts the message contents and the identity of the sender but not the identity of the recipient.

In step 510, the message delivery server determines whether to deliver the encrypted message based on a signed attestation (e.g., signed attestation 108) received with the request. In various embodiments, the message delivery server verifies the signed attestation using a verification key provide by the sender. In various embodiments, prior to receiving the request, the message delivery server sends, from the recipient to the sender, encrypted cryptographic material for obtaining the signed attestation. In some embodiments, the cryptographic material includes a plurality of tokens, and the signed attestation is one of the tokens. In some embodiments, the determining includes applying a verifiability oblivious pseudorandom function (VOPRF) to the signed attestation. In some embodiments, the cryptographic material includes a plurality of signature keys, and the signed attestation is signed using one of the signature keys. In some embodiments, the determining includes verifying the signed attestation using a first public key received from the sender and a second public key received from the recipient. In some embodiments, the cryptographic material includes a ring signature key, the signed attestation is a ring signature, and the determining includes verifying the ring signature using a public key capable of verifying ring signatures from a plurality of senders with distinct ring signature keys. In some embodiments, the cryptographic material includes a ring signature key of the sender and usable to identify a message signature tag appended by the revoked sender to an encrypted message.

In step 515, based on the determining, the message delivery server delivers the encrypted message to the recipient. In various embodiments, the message delivery server receives, from the recipient, a revocation request to revoke acceptance of signed attestations from the sender. In some embodiments, the revocation request identifies a set of public keys corresponding to a set of private keys provided by the recipient to the sender to sign the attestations. In some embodiments, the revocation request identifies a ring signature key of the sender and usable to identify a message signature tag appended by the revoked sender to an encrypted message.

Turning now FIG. 5B, a flow diagram of a method 530 is depicted. Method 530 is one embodiment of a method performed by a recipient device such as recipient device 130. Method 530 begins in step 535 with a recipient device sending, to a sender device (e.g., sender device 110), encrypted cryptographic material for attaching a delivery authorization attestation (e.g., signed attestation 108) to an encrypted message (e.g., encrypted message 104) that obfuscates the identity of the sender (e.g., encrypted sender identity 106). In step 540, the recipient device sends, to a message delivery server (e.g., message delivery server 120), a verification key for verifying the delivery authorization attestation. In step 545, the recipient device receivies the encrypted message from the message delivery server in response to a verification of the delivery authorization attestation using the verification key.

Turning now FIG. 5C, a flow diagram of a method 560 is depicted. Method 560 is one embodiment of a method performed by a sender device such as sender device 110. Method 560 begins in step 565 with a sender device receiving, from a recipient device (e.g., recipient device 130), encrypted cryptographic material for attaching a delivery authorization attestation (e.g., signed attestation 108). In step 570, the sender device encrypts a message (e.g., encrypted message 104) in a manner that obfuscates the identity of the sender (e.g., encrypted sender identity 106) to a message delivery server (e.g., message delivery server 120). In step 575, the sender device sends, to the message delivery server, the encrypted message with an attached delivery authorization attestation obtained from the cryptographic material.

### Exemplary Computer System

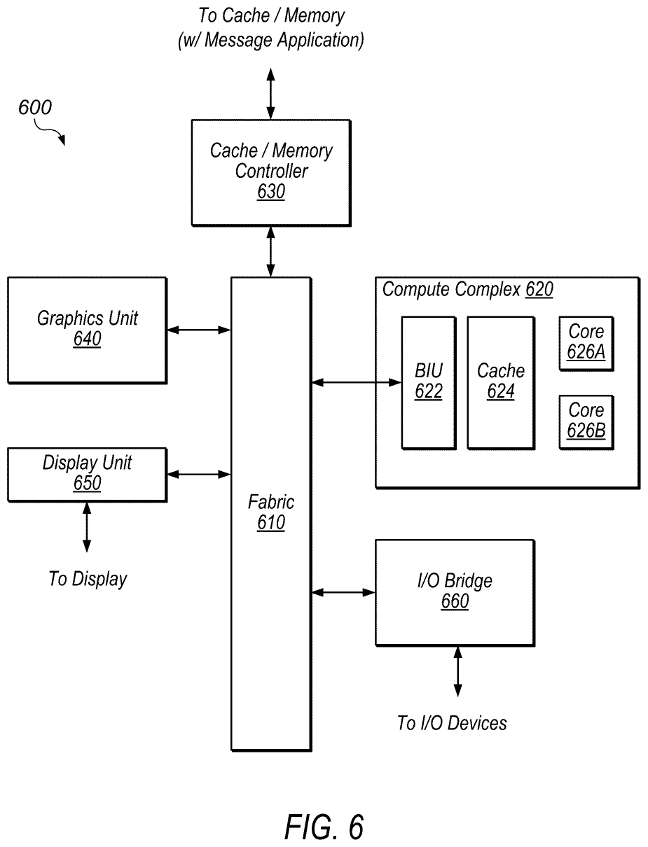

Turning now to FIG. 6, a block diagram illustrating an example embodiment of a system or device 600 is shown. In some embodiments system or device 600 may implement functionality of sender device 110, message delivery server 120, and/or recipient device 130. In some embodiments, elements of device 600 may be included within a system on a chip. In some embodiments, device 600 may be included in a mobile computing device, which may be battery-powered. Therefore, power consumption by device 600 may be an important design consideration. In the illustrated embodiment, device 600 includes fabric 610, compute complex 620 input/output (I/O) bridge 660, cache/memory controller 630, graphics unit 640, and display unit 650. In some embodiments, device 600 may include other components (not shown) in addition to or in place of the illustrated components, such as video processor encoders and decoders, image processing or recognition elements, computer vision elements, etc.

Fabric 610 may include various interconnects, buses, MUX's, controllers, etc., and may be configured to facilitate communication between various elements of device 600. In some embodiments, portions of fabric 610 may be configured to implement various different communication protocols. In other embodiments, fabric 610 may implement a single communication protocol and elements coupled to fabric 610 may convert from the single communication protocol to other communication protocols internally.

In the illustrated embodiment, compute complex 620 includes bus interface unit (BIU) 622, cache 624, and cores 626A-B. In various embodiments, compute complex 620 may include various numbers of processors, processor cores and caches. For example, compute complex 620 may include 1, 2, or 4 processor cores, or any other suitable number. In one embodiment, cache 624 is a set associative L2 cache. In some embodiments, cores 626A-B may include internal instruction and data caches. In some embodiments, a coherency unit (not shown) in fabric 610, cache 624, or elsewhere in device 600 may be configured to maintain coherency between various caches of device 600. BIU 622 may be configured to manage communication between compute complex 620 and other elements of device 600. Processor cores such as cores 626A-B may be configured to execute instructions of a particular instruction set architecture (ISA) which may include operating system instructions and user application instructions. These instructions may be stored in computer readable medium such as a memory coupled to memory controller 630 discussed below.

As used herein, the term “coupled to” may indicate one or more connections between elements, and a coupling may include intervening elements. For example, in FIG. 6, graphics unit 640 may be described as “coupled to” a memory through fabric 610 and cache/memory controller 630. In contrast, in the illustrated embodiment of FIG. 6, graphics unit 640 is “directly coupled” to fabric 610 because there are no intervening elements.

Cache/memory controller 630 may be configured to manage transfer of data between fabric 610 and one or more caches and memories. For example, cache/memory controller 630 may be coupled to an L3 cache, which may in turn be coupled to a system memory. In other embodiments, cache/memory controller 630 may be directly coupled to a memory. In some embodiments, cache/memory controller 630 may include one or more internal caches. Memory coupled to controller 630 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc.

Alternatively, the devices may be mounted with an integrated circuit in a chip-on-chip configuration, a package-on-package configuration, or a multi-chip module configuration. Memory coupled to controller 630 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions, such as messaging application for sending or receiving messages, delivery application for storing and filtering messages, etc., executable by compute complex 620 to cause device 600 to perform functionality described herein.

Graphics unit 640 may include one or more processors, e.g., one or more graphics processing units (GPUs). Graphics unit 640 may receive graphics-oriented instructions, such as OPENGL®, Metal®, or DIRECT3D® instructions, for example. Graphics unit 640 may execute specialized GPU instructions or perform other operations based on the received graphics-oriented instructions. Graphics unit 640 may generally be configured to process large blocks of data in parallel and may build images in a frame buffer for output to a display, which may be included in the device or may be a separate device. Graphics unit 640 may include transform, lighting, triangle, and rendering engines in one or more graphics processing pipelines. Graphics unit 640 may output pixel information for display images. Graphics unit 640, in various embodiments, may include programmable shader circuitry which may include highly parallel execution cores configured to execute graphics programs, which may include pixel tasks, vertex tasks, and compute tasks (which may or may not be graphics-related).

Display unit 650 may be configured to read data from a frame buffer and provide a stream of pixel values for display. Display unit 650 may be configured as a display pipeline in some embodiments. Additionally, display unit 650 may be configured to blend multiple frames to produce an output frame. Further, display unit 650 may include one or more interfaces (e.g., MIPI® or embedded display port (eDP)) for coupling to a user display (e.g., a touchscreen or an external display).

I/O bridge 660 may include various elements configured to implement: universal serial bus (USB) communications, security, audio, and low-power always-on functionality, for example. I/O bridge 660 may also include interfaces such as pulse-width modulation (PWM), general-purpose input/output (GPIO), serial peripheral interface (SPI), and inter-integrated circuit (I2C), for example. Various types of peripherals and devices may be coupled to device 600 via I/O bridge 660.

In some embodiments, device 600 includes network interface circuitry (not explicitly shown), which may be connected to fabric 610 or I/O bridge 660. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 600 with connectivity to various types of other devices and networks.

### EXAMPLE APPLICATIONS

Turning now to FIG. 7, various types of systems that may include any of the circuits, devices, or system discussed above. System or device 700, which may incorporate or otherwise utilize one or more of the techniques described herein, may be utilized in a wide range of areas. For example, system or device 700 may be utilized as part of the hardware of systems such as a desktop computer 710, laptop computer 720, tablet computer 730, cellular or mobile phone 740, or television 750 (or set-top box coupled to a television).

Similarly, disclosed elements may be utilized in a wearable device 760, such as a smartwatch or a health-monitoring device. Smartwatches, in many embodiments, may implement a variety of different functions-for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 700 may also be used in various other contexts. For example, system or device 700 may be utilized in the context of a server computer system, such as a dedicated server or on shared hardware that implements a cloud-based service 770. Still further, system or device 700 may be implemented in a wide range of specialized everyday devices, including devices 780 commonly found in the home such as refrigerators, thermostats, security cameras, etc. The interconnection of such devices is often referred to as the “Internet of Things” (IoT). Elements may also be implemented in various modes of transportation. For example, system or device 700 could be employed in the control systems, guidance systems, entertainment systems, etc. of various types of vehicles 790.

The applications illustrated in FIG. 7 are merely exemplary and are not intended to limit the potential future applications of disclosed systems or devices. Other example applications include, without limitation: portable gaming devices, music players, data storage devices, unmanned aerial vehicles, etc.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112 (f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. A non-transitory computer readable medium having program instructions stored therein that are executable by a computing system implementing a message delivery server to perform operations, comprising:
receiving a request to deliver an encrypted message from a sender to a recipient, wherein the encrypted message encrypts the identity of the sender such that the message delivery server is unable to determine the identity of the sender;
determining whether to deliver the encrypted message based on a signed attestation received with the request; and
based on the determining, delivering the encrypted message to the recipient.

2. The computer readable medium of claim 1, wherein the encrypted message is an email, a text message, a push notification, or a video or audio call request.

3. The computer readable medium of claim 1, wherein the operations further comprise:
verifying the signed attestation using a verification key provide by the sender.

4. The computer readable medium of claim 1, wherein the operations further comprise:
prior to receiving the request, sending, from the recipient to the sender, encrypted cryptographic material for obtaining the signed attestation.

5. The computer readable medium of claim 4, wherein the cryptographic material includes a plurality of tokens, and wherein the signed attestation is one of the tokens.

6. The computer readable medium of claim 4, wherein the cryptographic material includes a plurality of signature keys, and wherein the signed attestation is signed using one of the signature keys.

7. The computer readable medium of claim 4, wherein the cryptographic material includes a ring signature key, wherein the signed attestation is a ring signature, and wherein the operations further comprise:
verifying the ring signature using a public key capable of verifying ring signatures from a plurality of senders with distinct ring signature keys.

8. The computer readable medium of claim 1, wherein the operations further comprise:
receiving, from the recipient, a revocation request to revoke acceptance of signed attestations from the sender.

9. The computer readable medium of claim 8, wherein the revocation request identifies a set of public keys corresponding to a set of private keys provided by the recipient to the sender to sign the attestations.

10. The computer readable medium of claim 1, wherein the message encrypts the message contents and the identity of the sender but not the identity of the recipient.

11. A method, comprising:
receiving, by a message delivery server, a request to deliver an encrypted message from a sender to a recipient, wherein the encrypted message encrypts the identity of the sender such that the message delivery server is unable to determine the identity of the sender;
determining, by the message delivery server, whether to deliver the encrypted message based on a signed attestation received with the request; and
delivering, by the message delivery server and based on the determining, the encrypted message to the recipient.

12. The method of claim 11, further comprising:
sending, by the message delivery server and to the sender, encrypted cryptographic material for obtaining the signed attestation.

13. The method of claim 12, further comprising:
receiving, by the message delivery server and from the recipient, a revocation request to revoke acceptance of signed attestations obtained using the cryptographic material; and
denying a request to deliver another encrypted message received with a signed attestation obtained using the cryptographic material.

14. The method of claim 11, wherein the determining includes verifying the signed attestation using a ring signature public key associated with a plurality of senders.

15. The method of claim 11, wherein the determining includes applying a verifiability oblivious pseudorandom function (VOPRF) to the signed attestation.

16. The method of claim 11, wherein the determining includes verifying the signed attestation using a first public key received from the sender and a second public key received from the recipient.

17. A computing system, comprising:
one or more processors;
memory having program instructions stored therein that are executable by the one or more processors to cause the computing system to implement a message delivery server performing operations including:
receiving a request to deliver an encrypted message from a sender to a recipient, wherein the encrypted message encrypts the identity of the sender such that the message delivery server is unable to determine the identity of the sender;
determining whether to deliver the encrypted message based on a signed attestation received with the request; and
based on the determining, delivering the encrypted message to the recipient.

18. The computing system of claim 17, wherein the operations further include:
receiving, from the recipient, a revocation request to revoke acceptance of signed attestations from the sender, wherein the revocation includes cryptographic material associated with the attestations from the sender; and
determining, based on the cryptographic material, to reject another message from the sender.

19. The computing system of claim 18, wherein the cryptographic material includes one or more public keys corresponding to one or more private keys provided by the recipient to the sender to sign the attestations.

20. The computing system of claim 18, wherein the cryptographic material includes a ring signature key of the sender and usable to identify a message signature tag appended by the revoked sender to an encrypted message.
